(19) United States
(12) Patent Application Publication
(10) Pub. No.: US 2009/0043928 A1
(43) Pub. Date: Feb. 12, 2009

(54) INTERFACE DEVICE AND MASTER DEVICE OF A KVM SWITCH SYSTEM AND A RELATED METHOD THEREOF

(76) Inventor: Tony LOU, Taipei (TW)

Correspondence Address: BIRCH STEWART KOLASCH & BIRCH, PO BOX 747, FALLS CHURCH, VA, 22040-0747, US

(21) Appl. No.: 11/835,958

(22) Filed: Aug. 8, 2007

(51) Int. Cl. G06F 13/14

(52) U.S. Cl. 710/61

(57) ABSTRACT

The present invention centralizes the processing the combined horizontal and vertical sync signals in a master device and thereby keeps the interface devices as simple as possible so as to reduce the cost of the interface devices. The interface device mainly only converts the separate horizontal sync signal and vertical sync signal, or the combined horizontal and vertical sync signal to a default polarity. On the other hand, the separation of the combined horizontal and vertical sync signal into individual horizontal and vertical sync signals are all carried out by the master device.

### BACKGROUND OF THE INVENTION

1. Field of the Invention

The present invention generally relates to KVM switch systems, and more particularly to an interface device and a master device of a KVM switch system capable of processing the combined horizontal and vertical signals in an economical manner.

2. The Related Arts

KVM switch is widely popular in densely populated facility rooms as, instead of having dedicated keyboards, video displays, and mice, a single set of keyboard, video display, and mouse (therefore, the acronym KVM) is switched among and used to operate a large number of computers, thereby saving significant space and power, avoiding tangled wiring, and enhancing operational convenience.

For a conventional KVM switch, at least a cable is connected between the KVM switch and a computer for transmitting the video signal from the computer to the KVM switch for display on a video display connected to the KVM switch, and for transmitting the control signals from a keyboard and a mouse connected to the KVM switch to the computer for operating the computer. Then, by instructing the KVM switch to switch to another computer connected as such, the same video display can show the video output from the second computer and the same keyboard and mouse can be used to operate the second computer.

A recent development in the KVM switch is that twisted pair cables such as the Category 5 (CAT5) cables are used for the cabling between the KVM switch and the controlled computers as the CAT5 cables are able to provide signal transmission over an extended distance with high signal integrity. Usually, a small interface device is provided at a controlled computer and is connected to the keyboard, video, and mouse ports of the controlled computer. The interface device then converts the video signal to a format suitable for CAT5 cable and transmits the data to the KVM switch via a CAT5 cable, which decodes the data into the original video signal and sends the video signal to a connected video display. Similarly, the KVM switch encodes and sends the control signals from its connected keyboard and mouse to the interface device while the interface device decodes the data received from the KVM switch into original keyboard and mouse control signals and applies these control signals to the controlled computer.

U.S. Pat. No. 6,345,323 teaches a CAT5 KVM switch and the associated interface devices. In this teaching, the red, green, and blue video signals are transmitted over three twisted-pairs of the CAT5 cable, respectively. The horizontal and vertical sync signals are converted into positive going pulses and encoded onto two of the red, green, and blue video signals. The correct polarity of the horizontal and vertical sync signals is encoded onto the remaining one of the red, green, and blue video signals. In order to achieve conversion and encoding of the sync and polarity signals, sync combine and extract circuits are required in the interface devices. In some cases, the controlled computer provides a combined horizontal and vertical sync signal, instead of separate horizontal and vertical signals. To handle the combined horizontal and vertical sync signal, the sync combine and extract circuits would become quite complicated, thereby attributing a higher cost of the entire KVM switch system. In addition, these combine and extract circuits would introduce significant delay to the sync signals, which may cause shift and jitter in the displayed video. In the worst case, the video might not be properly displayed at all.

### BRIEF SUMMARY OF THE INVENTION

To overcome of the shortcomings of processing the combined horizontal and vertical sync signals in the prior arts, the present invention centralizes the processing the combined horizontal and vertical sync signals in a master device and thereby keeps the interface devices as simple as possible so as to reduce the cost of the interface devices.

According to the present invention, the interface device mainly only converts the separate horizontal sync signal and vertical sync signal, or the combined horizontal and vertical sync signal to a default polarity. On the other hand, the separation of the combined horizontal and vertical sync signal into individual horizontal and vertical sync signals are all carried out by the master device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the interface device according to an embodiment of the present invention.

FIG. 2 is a schematic diagram showing the pre-processing circuit of the interface device according to an embodiment of the present invention.

FIG. 3 is a schematic diagram showing the post-processing circuit of the master device according to an embodiment of the present invention.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

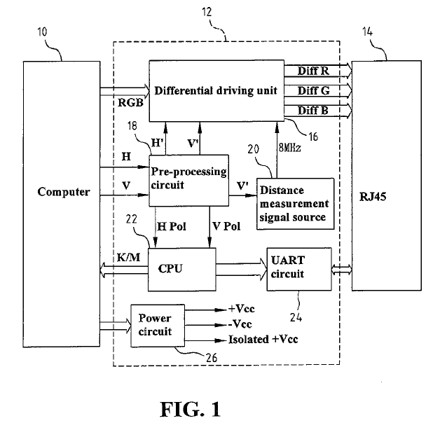

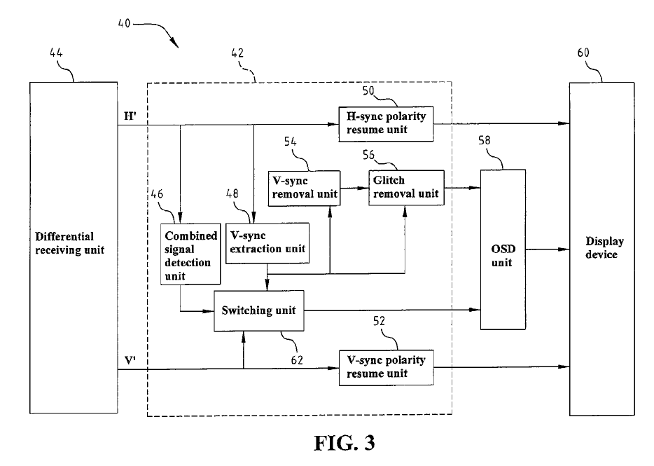

According to the present invention, a number of interface devices 12 (shown in FIG. 1) communicate with a master device 40 (shown in FIG. 3) through a number of cables, each having a number of twisted-pairs, respectively. As illustrated in FIG. 1, each interface device 12 is connected to the video port, the mousse connector, and the keyboard connector of a controlled computer 10. Please note that for simplicity these connectors and port are not explicitly shown in the drawing. On the other hand, the interface device 12 is connected to a cable 14 having a RJ-45 connector leading to the master device 40.

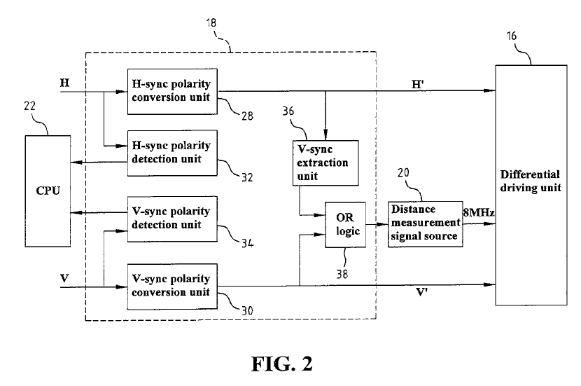

The horizontal sync signal (H) and the vertical sync signal (V) are obtained from the video port of the computer 10 and fed to a pre-processing circuit 18, whose details are shown in FIG. 2. As shown in FIG. 2, within the pre-processing circuit 18, the horizontal sync signal (H) is fed to and processed by an H-sync polarity conversion circuit 28 and an H-sync polarity detection circuit 32 in parallel. The H-sync polarity conversion circuit 28 converts the polarity of the horizontal sync signal (H) into a default polarity (e.g., positive polarity), and the H-sync polarity detection circuit 32 provides the original polarity (H pol) of the horizontal sync signal (H) to a central processing unit (CPU) 22. Similarly, the vertical sync signal (V) is fed to and processed by a V-sync polarity conversion circuit 30 and a V-sync polarity detection circuit 34 in parallel. The V-sync polarity conversion circuit 30 converts the polarity of the vertical sync signal (V) into a default polarity (e.g., positive polarity), and the V-sync polarity detection circuit 34 provides the original polarity (V pol) of the vertical sync signal (V) to the CPU 22.

As shown in FIG. 2, the converted horizontal sync signal (H′) and the converted vertical sync signal (V′) are then directly fed to a differential driver unit 16 of the interface device 12. The converted vertical sync signal (V′) is also fed to a distance measurement signal source 20 which provides an 8 MHz signal as a reference for the measurement of cable length in the master device 40. Based on the received converted vertical sync signal (V′), the distance measurement signal source 20 provides an 8 MHz signal that is synchronized with the converted vertical sync signal (V′). The synchronized 8 MHz signal is also fed to the differential driver unit 16.

However, there are cases that the horizontal sync lead of the video port provides a combined HV-sync signal while the vertical sync lead of the video port provides no signal. Therefore, a V-sync extraction unit 36 is provided to receive the output (i.e., in this case, a converted HV-sync signal) from the H-sync conversion circuit 28 so as to obtain the vertical sync signal. An additional OR logic 38 is therefore provided to receive the vertical sync signal either from the V-sync extraction unit 36 or from the V-sync conversion unit 30. The output of the OR logic 38 is then fed to the distance measurement unit 20 as the reference for synchronizing the 8 MHz signal. Please note that a major feature of the present invention is that the pre-processing circuit 18 does not provide any processing to the combined horizontal and vertical sync signal, which is fed to the differential driver unit 16 as it is. The complicated horizontal and vertical sync separation process is centralized and carried out by the mater device 40 altogether so as to simplify the interface device 12 and to reduce the cost of the interface device 12. Please also note that the synchronization to the 8 MHz signal is not required to be highly precise and, therefore, the V-sync extraction unit 26 can be implemented using simple resistor and capacitor (RC) circuit.

As shown in FIG. 1, the red, green, and blue video signals (RGB) are obtained from the video port of the computer 10 and fed to the differential driver unit 16. The differential driver unit 16 then produced differential red, green, and blue video signals with the converted horizontal sync signal (H′), the converted vertical sync signal (V′), and the synchronized 8 MHz signal encoded onto them, respectively, denoted as Diff R, Diff G, and Diff B in FIG. 1. The signals Diff R, Diff G, and Diff B are then applied to appropriate twisted-pairs of the cable 14, respectively, for transmission to the master device 40.

The CPU 22 performs at least two tasks. One task is to transmit the original polarity (H pol) of the horizontal sync signal (H) and the original polarity (V pol) of the vertical sync signal (V) to the master device via an UART (Universal Asynchronous Receiver Transmitter) circuit 24 and the cable 14. The other task is to receive the keyboard and mouse control signals from the master device 40 via the cable 14 and the UART circuit 24, and apply the keyboard and mouse control signals to the keyboard and mouse connectors of the computer 10.

As shown in FIG. 1, the interface device 12 contains a power circuit 26 which provides the appropriate voltages such as +Vcc, −Vcc, and Isolated +Vcc, etc. to the foregoing components of the interface device 12. The power circuit 26 obtains electricity from the computer 10 via the interface device 12's connection to the computer 10's keyboard and/or mouse connectors.

FIG. 3 shows a major part of the master device 40 in processing the video signals from the interface devices 12. The rest of the master device 40 for switching and for processing the keyboard and mouse control signals is similar to those of the prior arts and is omitted here for simplicity. As illustrated, the master device 40 contains a differential receiving unit 44 which extracts the converted horizontal sync signal (H′) and the converted vertical sync signal (V′) from the data transmitted from an interface device 12. As mentioned earlier, if the video port of a controlled computer 10 provides only a combined HV-sync signal, what is extracted by the differential receiving unit 44 would be a converted HV-sync signal only as the H′ signal and there is no V′ signal.

Regardless whether the horizontal and vertical sync signals are combined or not, the extracted H′ and V′ signals are fed to a post-processing circuit 42 of the master device 40. As also mentioned earlier, the original polarities of the H′ and V′ signals are transmitted to the master device 40 via a CAT5 cable as well. Therefore, the post-processing circuit 42 restores the extracted H′ and V′ signals to have their original polarities by an H-sync polarity resume unit 50 and a V-sync polarity resume unit 52, respectively. The restored signals are then directly applied to the video port of a display device 60.

The master device 40 also contains an on-screen display (OSD) unit 58 for controlling the display device 60.

The post-processing circuit 42 contains a combined signal detection unit 46 which receives the H′ signal. If the combined signal detection unit 46 determines that the H′ signal is not the converted HV-sync signal, it will instruct a switching unit 62 of the post-processing circuit 42 to output the converted vertical sync signal (V′) to the OSD unit 58. On the other hand, if the combined signal detection unit 46 determines that the H′ signal is the converted HV-sync signal, it will instruct the switching unit 62 to output the converted vertical sync signal (V′) extracted from the converted HV-sync signal by a V-sync extraction unit 48. The converted vertical sync signal (V′) is also fed to a V-sync removal unit 54 and a glitch removal unit 56 of the post-processing unit 56 in parallel.

The V-sync removal unit 54 takes both the H′ signal and the output of the V-sync extraction unit 48 as inputs. If the H′ signal is the converted HV-sync signal, the V-sync removal unit 54 subtracts the converted vertical sync signal (V′) extracted by the V-sync extraction unit 48 from the converted HV-sync signal so as to obtain the converted H-sync signal. The converted H-sync signal is then put though the glitch removal unit 56 and then fed to the OSD unit 58. If the H′ signal is the converted H-sync signal, the V-sync extraction unit 48 obtains nothing and the V-sync removal unit 54 ends up sending the converted H-sync signal to the OSD unit 58 via the glitch removal unit 56.

As described above, the centralized processing of the separation of the combined HV-sync signal is able to provide more precise processing and more stable display to avoid flickering, drifting, etc. in the displayed video of the display device 60.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An interface device connected to a video port of a computer for sending video signals from said computer to a master device via a twisted-pair cable, said interface device comprising:
a pre-processing receiving a first sync signal and a second sync signal from a horizontal sync lead and a vertical sync lead of said video port, respectively, said pre-processing circuit having
a first polarity conversion unit converting said first sync signal into having a default polarity;
a first polarity detection unit obtaining a first original polarity from said first sync signal;
a second polarity conversion unit converting said second sync signal into having said default polarity;
a second polarity detection unit obtaining a second original polarity from said second sync signal;
a sync extraction unit obtaining a vertical sync signal from said first sync signal when said first sync signal is a combined horizontal and vertical sync signal; and
an OR logic producing a sum of said vertical sync signal and said second sync signal;
a distance measurement signal source producing a pulse signal synchronized with said sum of said vertical sync signal and said second sync signal;
a differential driver unit receiving red, green, and blue video signals from said video port, said first sync signal having said default polarity, said second signal having said default polarity, and said pulse signal, and producing differential red, green, and blue video signals with said first sync signal having said default polarity, said second signal having said default polarity, and said pulse signal encoded, respectively, and sending said differential red, green, and blue video signals to said master device via said twisted-pair cable; and
a central processing unit sending said first and second original polarities to said master device via said twisted-pair cable.

2. The interface device according to claim 1, wherein said pulse signal is an 8 MHz pulse.

3. The interface device according to claim 1, wherein said default polarity is positive polarity.

4. The interface device according to claim 1, wherein said sync extraction unit is a RC circuit.

5. A method for processing and sending video signals from a computer to a master device via a twisted-pair cable, said method comprising the steps of:
receiving a first sync signal and a second sync signal from said computer;
obtaining a first original polarity and a second original polarity from said first and second sync signals, respectively;
converting said first and second sync signals into having a default polarity, respectively;
obtaining a vertical sync signal from said first sync signal when said first sync signal is a combined horizontal and vertical sync signal;
producing a sum of said vertical sync signal and said second sync signal
producing a pulse signal synchronized with said sum of said vertical sync signal and said second sync signal;
receiving red, green, and blue video signals from said computer, said first sync signal having said default polarity, said second signal having said default polarity, and said pulse signal, and producing differential red, green, and blue video signals with said first sync signal having said default polarity, said second signal having said default polarity, and said pulse signal encoded, respectively, and sending said differential red, green, and blue video signals to said master device via said twisted-pair cable; and
sending said first and second original polarities to said master device via said twisted-pair cable.

6. A master device connected to a video port of a display device for sending video signals received from one of a plurality of interface devices a twisted-pair cable, said master device comprising:
a differential receiving obtaining a first sync signal, a second sync signal, a first original polarity, and a second original polarity from said twisted-pair cable;
a first polarity resume unit converting said first sync signal into having said first original polarity and applying said first sync signal into having said first original polarity to said video port;
a second polarity resume unit converting said second sync signal into having said second original polarity and applying said second sync signal into having said second original polarity to said video port;
a sync extraction unit obtaining a converted vertical sync signal from said first sync signal when said first sync signal is a converted combined horizontal and vertical sync signal;
a combined signal detection unit determining whether said first sync signal is a converted combined horizontal and vertical sync signal;
a switching unit, based on a decision provided by said combined signal detection unit, providing said second sync signal from said differential receiving unit when said first sync signal is not a converted combined horizontal and vertical sync signal, and providing said converted vertical sync signal from said sync extraction unit when said first sync signal is a converted combined horizontal and vertical sync signal;
a sync removal unit obtaining a converted horizontal sync signal by removing said converted vertical sync signal of said sync extraction unit from said first sync signal when said first sync signal is a converted combined horizontal and vertical sync signal;
a glitch removal unit removing glitches from said converted horizontal sync signal; and
an on-screen-display unit applying said glitch-removed converted horizontal sync signal and said converted vertical signal to said video port.

7. A method for processing and sending video signals from an interface device to a display device having an on-screen display unit via a twisted-pair cable, said method comprising the steps of:
obtaining a first sync signal, a second sync signal, a first original polarity, and a second original polarity from said twisted-pair cable;
converting said first sync signal into having said first original polarity and applying said first sync signal having said first original polarity to said video device;
converting said second sync signal into having said second original polarity and applying said second sync signal having said second original polarity to said video device;
obtaining a converted vertical sync signal from said first sync signal when said first sync signal is a converted combined horizontal and vertical sync signal;
providing said second sync signal when said first sync signal is not a converted combined horizontal and vertical sync signal, and providing said converted vertical sync signal when said first sync signal is a converted combined horizontal and vertical sync signal;
obtaining a converted horizontal sync signal by removing said converted vertical sync signal from said first sync signal when said first sync signal is a converted combined horizontal and vertical sync signal;
removing glitches from said converted horizontal sync signal; and
applying said glitch-removed converted horizontal sync signal and said converted vertical signal to said on-screen display unit.
